(19) United States
(12) Patent Application Publication
(10) Pub. No.: US 2011/0223468 A1
(43) Pub. Date: Sep. 15, 2011

(54) Variable Energy System

(75) Inventor: Robert R. Ferber, JR., Woodside, CA (US)

(73) Assignee: Electronvault, Inc.

(21) Appl. No.: 12/724,382

(22) Filed: Mar. 15, 2010

(51) Int. Cl. H01M 2/24; B23P 17/04

(52) U.S. Cl. 429/160; 29/623.1; 29/401.1

(57) ABSTRACT

An energy system is provided that may be reconfigured, repaired, upgraded, and remanufactured through, for example, removal and replacement of various components of the energy system such as power cells, releasable modular interconnects, and the like. In this regard, a reconfigurable energy system may include a plurality of power cells and a releasable modular interconnect configured to form releasable electrical connections to a terminal of each of the plurality of power cells. The electrical connections may be releasable through application of a first non-destructive interconnect removal force to the releasable modular interconnect to provide for non-destructive removal of the releasable modular interconnect from the energy system. Additional and related methods and apparatuses are also provided.

### CROSS-REFERENCE TO RELATED APPLICATIONS

This application is related to application Ser. No. 12/______ (titled “Modular Interconnection System”), Ser. No. 12/______ (titled “Impedance Balancer”), and Ser. No. 12/______ (titled “Power Cell Array Receiver”), each filed on Mar. 15, 2010, and each of which are incorporated herein by reference in their entirety.

### TECHNICAL FIELD

Embodiments of the present invention relate generally to energy systems, and, more particularly, relate to a variable, reconfigurable, upgradeable, maintainable, and remanufacturable energy system.

### BACKGROUND

Energy storage and generation technologies are rapidly evolving as consumers increase their demand for energy solutions that are both convenient and environmentally-friendly. Systems often include a number of smaller cells, such as rechargeable battery cells, that are electrically connected together. In many systems, these cells are tack welded together to form the electrical connections between the cells. The connections between the cells may be configured such that the system supports a permanent voltage and current capacity configuration for use in a single application for the energy system.

### BRIEF SUMMARY

Example embodiments of the present invention include an energy system that is readily reconfigurable to thereby vary the voltages and current capacities to support the operational requirements of different loads. In this regard, a reconfigurable energy system may include a plurality of power cells and a releasable modular interconnect configured to form releasable electrical connections to a terminal of each of the plurality of power cells. The releasable modular interconnect may be removable and replaceable with another releasable modular interconnect to thereby generate different electrical configuration of the power cells. The electrical connections may be releasable through application of a non-destructive interconnect removal force to the releasable modular interconnect. The releasable electrical connections also contribute to generating an electrical configuration of the plurality of power cells defined by a number of series connected, parallel groups of power cells and a number of power cells in each parallel group via a releasable modular interconnect or a set of complementary releasable modular interconnects. It should be understood that although electrical configurations may be expressed herein as defined by a series connected, parallel group relationship; in fact, series connected power cells and parallel connected power cell electrical configurations are also included in this definition. Further, by removing the first releasable modular interconnect, or the set of complementary releasable modular interconnects, from the reconfigurable energy system and installing a different releasable modular interconnect, or a different set of complementary releasable modular interconnects, in the reconfigurable energy system, different output voltages and current carrying capacities can be achieved. Access to add, remove, exchange, or replace power cells or other components of the energy system for repair, upgrade, or remanufacture is facilitated by removing the first releasable modular interconnect, or the set of complementary releasable modular interconnects, from the reconfigurable energy system. A detailed description of example reconfigurable energy systems and additional example embodiments of the present invention are further described below.

### BRIEF DESCRIPTION OF THE DRAWING(S)

Reference will now be made to the accompanying drawings, which are not necessarily drawn to scale, and wherein:

FIG. 1 is an illustration of an overhead view of an example reconfigurable energy system according to various example embodiments;

FIG. 2 illustrates an example reconfigurable energy system in an exploded view according to various example embodiments;

FIG. 3 illustrates a top view of an reconfigurable energy system housing an array of power cells according to various example embodiments;

FIG. 4 illustrates an example cutaway side view of a portion of an reconfigurable energy system according to various example embodiments;

FIG. 5 illustrates an example cutaway side view of a portion of another reconfigurable energy system according to various example embodiments;

FIG. 6 illustrates an example releasable modular interconnect according to various example embodiments;

FIGS. 7 and 8 illustrate examples of detailed contact regions of the releasable modular interconnect of FIG. 6 according to various example embodiments;

FIG. 9 illustrates the example releasable modular interconnect of FIG. 6 with a complementary example releasable modular interconnect according to various example embodiments;

FIGS. 10 and 11 illustrate example electrical configurations that may be generated by an example releasable modular interconnect according to various example embodiments;

FIGS. 12 and 13 illustrate additional releasable modular interconnects according to various example embodiments;

FIG. 14 is an illustration of a reconfiguration process of an energy system according to various example embodiments;

FIG. 15 is a flowchart of an example method for reconfiguring an energy system according to various example embodiments;

FIG. 16 is flowchart of an example method of manufacturing a reconfigurable energy system according to various example embodiments; and

FIG. 17 is a flowchart of an example method of remanufacturing or upgrading a energy system according to various example embodiments.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein. Like reference numerals refer to like elements throughout.

According to various example embodiments of the present invention, a reconfigurable energy system including a plurality of power cells is provided that may be configured, via releasable modular interconnects, to generate an electrical configuration of the power cells to support a desired voltage and current capacity output for the energy system. According to some example embodiments, the releasable modular interconnect may be configured to form releasable electrical connections with the plurality of power cells within an energy system. A power cell may be any type of apparatus that outputs power. Differing technologies of power cells may include, for example electrochemical or electrostatic cells, which may include batteries (e.g., lithium-ion, lead-acid, metal-air batteries, and the like), capacitors (e.g., ultracapacitors, supercapacitors, and the like), fuel cells, photovoltaic cells, Peltier junction devices, piezoelectric cells, thermopile devices, other solid state conversion cells, other hybrids of electrochemical and electrostatic cells, or the like, and combinations thereof. Further, different power cell technologies may also include different chemistries. Each power cell may, for example, be a cylindrical or prismatic device that includes a positive and negative terminal. Releasable electrical connections may be formed with the positive or negative terminals of a power cell via releasable contacts of a releasable modular interconnect. The releasable modular interconnect may be designed in accordance with one of a variety of patterns for connecting the power cells. For a given pattern, parallel and series connections between the power cells are formed, which determines the output voltage and current capacity of the reconfigurable energy system. A releasable modular interconnect can also include positive and negative polarity interconnect output terminals for outputting the voltage and current capacity that is provided by the electrical configuration of the power cells. In this regard, the output voltage of the reconfigurable energy system may be measured across the interconnect output terminals.

According to various example embodiments, because the electrical connections between the releasable modular interconnect and the power cells are releasable, a reconfigurable energy system that utilizes a releasable modular interconnect can be readily maintained. In this regard, a releasable electrical connection may be an electrical connection that is formed by a force or pressure that is applied between a conductive releasable contact of the releasable modular interconnect and a terminal of a power cell. According to some example embodiments, the releasable modular interconnect can be removed or detached from the power cells and the reconfigurable energy system by overcoming any forces that hold the releasable modular interconnect in place. The forces that hold the releasable modular interconnect in place may be overcome by, for example, lifting the releasable modular interconnect away from the power cells. A non-destructive interconnect removal force (e.g., a lifting force) may be applied to the releasable modular interconnect to separate the releasable modular interconnect from the power cells and the reconfigurable energy system, and provide access to the power cells. According to some example embodiments, the releasable modular interconnect, after being accessed through removal of, for example, a housing cover, may be removed without the use of tools. The releasable modular interconnect may be held in alignment by, for example, alignment pins, grooves, springs, magnets, or a cover associated with a housing, wherein the cover may have springs, alignment pins, or the like for holding the releasable modular interconnect in place. According to some example embodiments, the removal of the releasable modular interconnect can be performed in a non-destructive manner such that no component of the reconfigurable energy system must be discarded or repaired as a result of removal of the releasable modular interconnect from the reconfigurable energy system. For example, a non-destructive removal force can be used to remove a releasable modular interconnect, which may be a force that does not alter the components affected by the force in a manner that cannot be remedied by a replacement force. As a result of this feature, some example embodiments provide for maintenance of the reconfigurable energy system in an efficient and inexpensive manner.

Further, a reconfigurable energy system can be utilized in environments that experience vibrations, such as, for example, being affixed to a moving vehicle or bike. Because, according to some example embodiments, the connections between the releasable contacts of the releasable modular interconnect are permitted to move slightly while maintaining an electrical connection, fatigue on the releasable contacts is reduced or eliminated, relative to a fixed, for example tack welded, connection. Fatigue can cause degradation in the quality of a fixed connection, and result in reduced power transfer efficiency. Since some example embodiments are not affected by vibrations in the same way a fixed connection is affected, improved power transfer can be realized, particularly over the life of a reconfigurable energy system.

The releasable electrical connections also facilitate removal of a releasable modular interconnect from the reconfigurable energy system for replacement with another releasable modular interconnect resulting in a different electrical configuration of the power cells and corresponding voltage and current capacity. Further, under, for example, maintenance conditions, the removed releasable modular interconnect may be re-installed in the reconfigurable energy system after maintenance of, for example, the cells is complete. Since the removal and replacement of the releasable modular interconnect may be performed in a non-destructive manner, the releasable modular interconnect provides for increased application flexibility for a reconfigurable energy system. A reconfigurable energy system having a first electrical configuration of power cells via a first releasable modular interconnect, can be removed and replaced by a second releasable modular interconnect that provides a second electrical configuration of the power cells. In this manner, an energy system can be reconfigured to support a variety applications that require different voltages or current carrying capacities. Replacement of a releasable modular interconnect can also facilitate electrical reconfiguration of energy systems that have already been deployed in the field.

Further, according to some example embodiments, the forces applied to form the releasable electrical connections between the contacts of the releasable modular interconnect and the terminals of power cells may be generated through implementation of one or more magnetic members. In this regard, a magnetic member may be associated with each contact of the releasable modular interconnect (e.g., either affixed to the contact or affixed to the terminal of the power cell) that magnetically couples to the power cell or the terminal of the power cell. The magnetic coupling can generate a force that holds the releasable contact in electrical connection with the terminal of the power cell to form the releasable electrical connection.

According to various example embodiments, the layout of conductive interconnect members of a releasable modular interconnect may be defined by a pattern for connecting the various power cells in a desired electrical configuration. The conductive interconnect members may include releasable contacts that are configured to form the electrical connections with the terminals of the power cells. According to some example embodiments, a releasable modular interconnect may be constructed to be flexible. In this regard, a flexible releasable modular interconnect may be comprised of one or more layers of a flexible substrate and, the conductive interconnect members may be comprised of a conductive, flexible foil. According to some example embodiments, the flexibility of a releasable modular interconnect not only supports the non-destructive removal of the releasable modular interconnect, as described herein, but also allows the releasable contacts of the releasable modular interconnect to deform or deflect to maximize the amount of surface area of the contacts that interacts with the terminals of the power cells. As a result, improved electrical connections can be realized. Further, according to some example embodiments, due to a thin profile of some example releasable modular interconnects, heat dissipation from the power cells may also be increased.

Reconfigurable energy systems that utilize releasable modular interconnects may be employed in a variety of settings. For example, vehicles, including cars, trucks, bikes, and the like, may be powered by a reconfigurable energy system and recharged when the vehicles are not in use or though mechanisms, such as, for example, energy recapture techniques. Additionally, reconfigurable energy systems may be utilized in coordination with smart grid technologies to perform, for example, grid services such as peak shaving, backup power, and the like. Further, due to the adaptability of reconfigurable energy systems via replacement of releasable modular interconnects, an energy storage system may be reconfigured and repurposed such that, for example, a reconfigurable energy system may be used with an electric bike that requires a 12 volt supply, and through replacement of the releasable modular interconnect, the same energy storage system may be used as backup power system for a household inverter that requires a 24 volt supply voltage.

In some embodiments, a reconfigurable energy system, via removal of releasable modular interconnects, can provide access to the power cells and other components of the system that are themselves removable (e.g., containment panels, output buses, balancing circuitry, etc.). In some of these example embodiments, power cells and other components may be replaced, for example, if they have failed, or removed permanently or temporarily as part of a maintenance cycle for a reconfigurable energy system. In some of example embodiments, a maintenance cycle may require additional power cells or components be added to or removed from a reconfigurable energy system. In some of example embodiments, power cells and other components may be exchanged for different technology or new components, or technology may be added as part of an upgrade or remanufacture of the reconfigurable energy system. In some example embodiments, the number of power cells may be increased or decreased depending upon new power cell technology being introduced into a reconfigurable energy system. In some example embodiments, a reconfigurable energy system may be deployed into the field without a full complement of power cells, leaving room for additional or different power cells to be added to a reconfigurable energy system based upon a customer's or seller's preference for performance, price, or other market-based characteristics of a reconfigurable energy system.

In some embodiments, a reconfigurable energy system is comprised of a variety of components which may be independently integrated into a system, including mixing different power cell technologies together into the same system.

As such, according to various example embodiments, a reconfigurable energy system may be reconfigurable by (a) changing an releasable modular interconnect (or complementary set of releasable modular interconnects) with another releasable modular interconnect (or complementary set of releasable modular interconnects) of a different pattern, (b) replacing the power cells of the energy system with power cells of a different technology, for example, one battery cell for a battery cell of a different battery chemistry, (c) adding power cells if room is available, or (d) removing power cells. In this manner, any component of the energy system may be reconfigured, replaced, or otherwise maintained. Further, as a result of the flexibility that is realized, a energy system may be remanufactured and components may be recycled for a second purpose (i.e., Second Life or downstream applications) after, for example, an energy system requires maintenance or a pressing need arises for an alternatively configured energy system. In this regard, an energy system may be remanufactured to support deployment in a solar photovoltaic setting, a wind farm setting, or a grid/off-grid storage system.

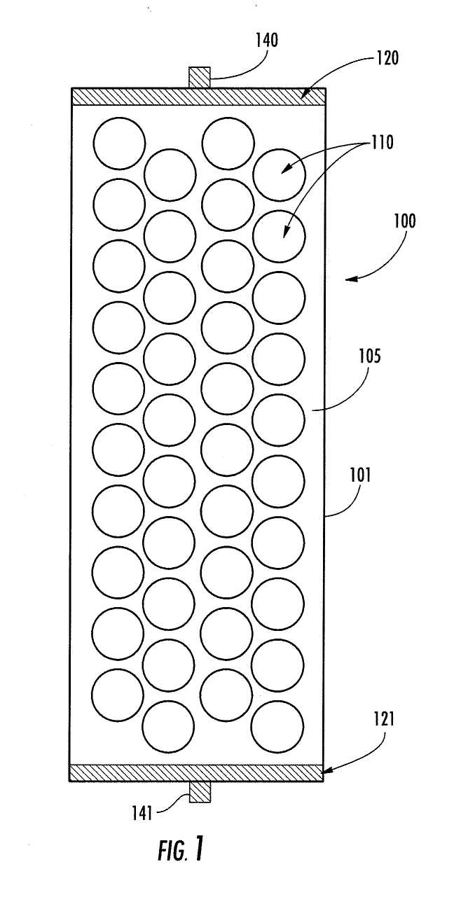

FIG. 1 illustrates an overhead view of an example arrangement of power cells within a reconfigurable energy system 100, which includes a power cell array receiver (PCAR) 105. The PCAR 105 includes apertures 110 for receiving and holding the power cells. While FIG. 1 depicts apertures 110 in an example hexagonal grid arrangement for holding forty power cells, it is contemplated that a PCAR may be designed to hold any number of power cells in various positions and arrangements. Since power cells often have one or more terminals on a top or bottom surface, the arrangement of the apertures can provide a general indication of the placement of releasable contacts for a releasable modular interconnect.

Based on the releasable contact locations, various patterns for a releasable modular interconnects may be designed to generate desired voltages and current capacity characteristics for the reconfigurable energy system 100. The reconfigurable energy system 100 also includes output buses 120 and 121 that are positioned to form an electrical connection with interconnect output terminals of a releasable modular interconnect, and in some example embodiments, the connection with the output buses can be formed with the assistance of a magnetic force produced by associated magnetic members. The output busses may be positioned at various locations within the reconfigurable energy system, such as, for example, on any one side or arrangement of two sides. Similar to the releasable electrical connection between the releasable contacts and the terminals of the power cells, the electrical connection between the interconnect output terminals and the output buses 120 and 121 may be releasable. According to some example embodiments, the output buses 120 and 121 may be electrically connected to energy system output terminals 140 and 141, respectively. The energy system output terminals may ultimately be connected to an external device, such as, for example, a load or other reconfigurable energy system to facilitate, for example, the delivery of power. While the output buses 120 and 121, and the energy system outputs 140 and 141 are depicted at opposite ends of the reconfigurable energy system 100 in FIG. 1, it is contemplated that the output buses 120 and 121, and energy system output terminals 140 and 141 may be positioned at various locations within the housing 101 of the reconfigurable energy system 100. For example, the output buses and energy system output terminals may be positioned on the same end of the housing 101 or the output buses 120 and 121 may be positioned along the longitudinal edges of the housing. Corresponding placement of the interconnect output terminals within the releasable modular interconnect is also contemplated.

A reconfigurable energy system may be designed to be adaptable to a number of component technologies. For example, various power cell technologies may be supported by the design of the reconfigurable energy system. Further, differing technologies of other components of the reconfigurable energy system may be supported. For example, the reconfigurable energy system may be configured to support a battery management system technology that perform cell bleed-off for power cell balancing, or a battery management system that supports impendence balancing for power cell balancing. According to some example embodiments, components, such as the battery management system, may be replaceable via a non-destructive removal force because the removal of an releasable modular interconnect provides accessibility to the components.

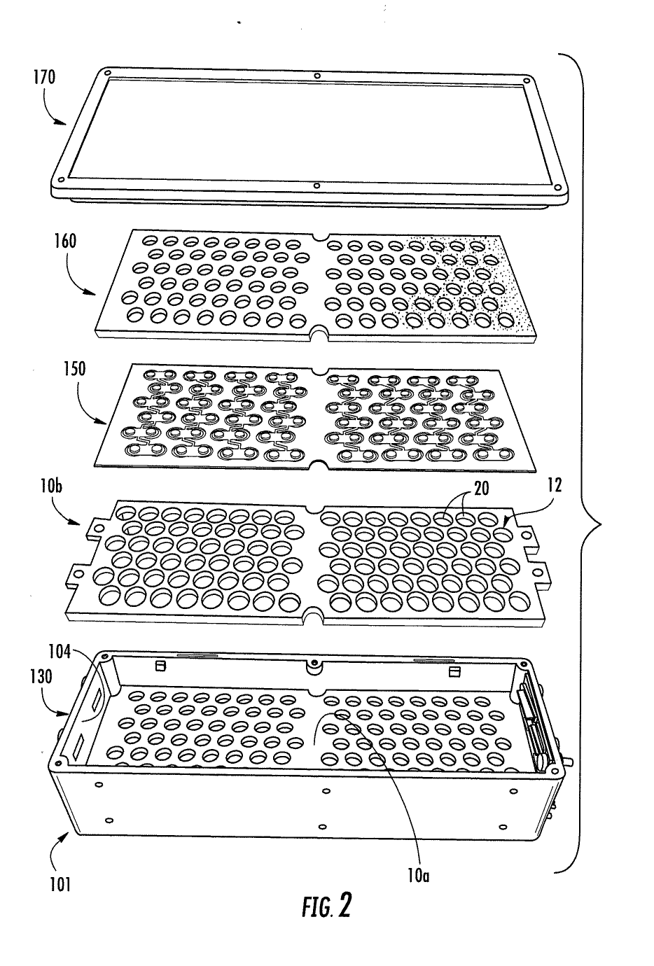

FIG. 2 illustrates an example reconfigurable energy system in an exploded view depicting various components of the reconfigurable energy system. The first containment panel 10a and second containment panel 10b can be releasably attached to a separate housing 101 such that one or more power cells can be received and secured, at least with respect to lateral movement, therein. The containment panels may each have a number of corresponding apertures 20 for receiving and holding respective power cells. After attaching the respective containment panels 10a, 10b into the desired position (e.g., affixed as parallel planes within the housing 101), one or more power cells can be disposed within respective apertures of the containment panels 10. That is, a single power cell can be disposed within a pair of corresponding apertures 20. Further, each aperture 20 of the containment panels may be configured to receive a power cell and laterally hold the power cell in a position that corresponds to a respective releasable contact of a releasable modular interconnect.

Once the power cells are in position, a releasable modular interconnect 150 can be positioned overlay the upward facing surfaces of the power cells to form releasable connections with one or more of the terminals of each power cell and contribute to forming a desired electrical configuration of power cells. Generally, a releasable modular interconnect 150 comprises conductive interconnect members acting to connect the power cells together to form an electrical configuration of power cells. In some example embodiments, an electrical connection between the releasable contacts of the releasable modular interconnect and the terminals of the power cells is formed by disposing an electrically conductive paste or grease between the terminals of the power cells and the releasable contacts. Although not shown in FIG. 2, the releasable modular interconnect 150 can be electrically connected to one or more output buses of the reconfigurable energy system. As described with respect to FIG. 1, the output buses can be mounted on or proximate to the containment panels on the sides of housing 101. After the power cells are electrically connected to the releasable modular interconnect 150, a shock absorbing cushion 160, may be positioned over the releasable modular interconnect 150. Finally, a lid 170 can be releasably attached to the housing to provide an enclosed reconfigurable energy system. Although not illustrated in FIG. 2, the lower half of the reconfigurable energy system is configured in the same manner, and can be similarly disassembled and reassembled. In particular, the lower half of the reconfigurable energy system may include a second releasable modular interconnect that is complementary to the releasable modular interconnect 150. The releasable modular interconnects can combine to generate a desired electrical configuration of power cells.

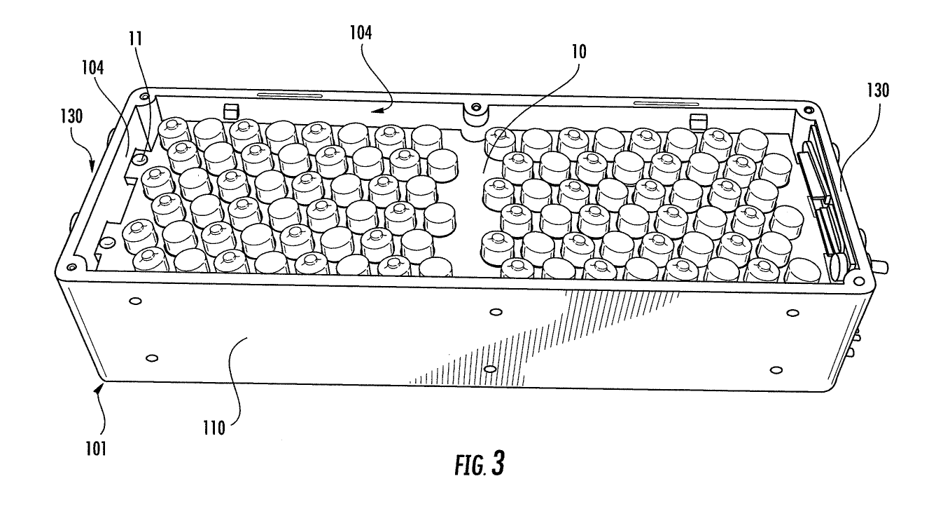

With reference to FIG. 2, the reconfigurable energy system may be disassembled such that the releasable modular interconnect 150 is removed from the upward facing surfaces of the power cells, as depicted in FIG. 3, which is a more detailed perspective of a portion of a reconfigurable energy system. The housing 101 includes a pair of opposing side panels 110 and a pair of opposing end panels 130 which may be parts of single, for example molded, component. The housing 100, however, need not be a single component. For example, each of the panels can be releasably attached to one another to form a structurally similar housing. In the example embodiment shown in FIG. 3, the containment panels 10 are attached to at least one inside portion 104 of the housing by bolts 11, screws, or the like. Further, an array of power cells 2 are disposed within respective apertures of the containment panels 10. Each power cell 2 may be oriented within a respective aperture 20 in a given polarity orientation (e.g., either a positive terminal facing up position or a positive terminal facing down position). With reference to the power cells 2 of FIG. 3, every other column of cells may be oriented in an opposite polarity orientation, generating a mixed polarity orientation for the reconfigurable energy system. In this regard, the mixed polarity orientation of the power cells 2 may contribute, in addition to the use of the releasable modular interconnect, to the electrical configuration of the power cells for the reconfigurable energy system.

Through removal of the releasable modular interconnect 150 via, for example a non-destructive interconnect removal force, the power cells 2 may be accessible as depicted in FIG. 3. In this configuration, the power cells, the releasable modular interconnects, and other components of the energy system including the containment panels, the output busses, output terminals, bus bars, accessories (e.g., balancing circuitry, monitoring circuitry, fans, alarms, third party components, and the like) may be added, removed, maintained, or replaced. According to various example embodiments, the components of the reconfigurable energy system, may be removed via a non-destructive component removal force. In this regard, the power cells 2 may be individually removed or otherwise interacted with, for example, to be tested for maintenance purposes. For example, if one of the power cells 2 needs to be replaced due to failure of the cell, regular maintenance, upgrading, or remanufacturing, the power cell to be replaced may be removed via a non-destructive cell removal force. The removed power cell may then be replaced by another power cell, possibly of a different technology. Further, according to some example embodiments, after replacement of the cell, the releasable modular interconnect 150 may be re-installed and the reconfigurable energy power system may be prepared for use (e.g., by replacing the lid 170.) A similar procedure may be implemented to replace any other component of the energy system. Further, according to various example embodiments, components of the energy system may be reoriented within the energy system, for example, as part of a remanufacturing process. In this regard, for example, cells with a positive terminal on a single face of the cell may be positioned such that mixed orientation of the array of cells is achieved. See, for example, the mixed orientation of cells depicted in FIG. 3. Additionally, other components, such as output busses or bus bars may be reoriented (e.g., moved from being on a common side of the energy to opposite sides of the energy system).

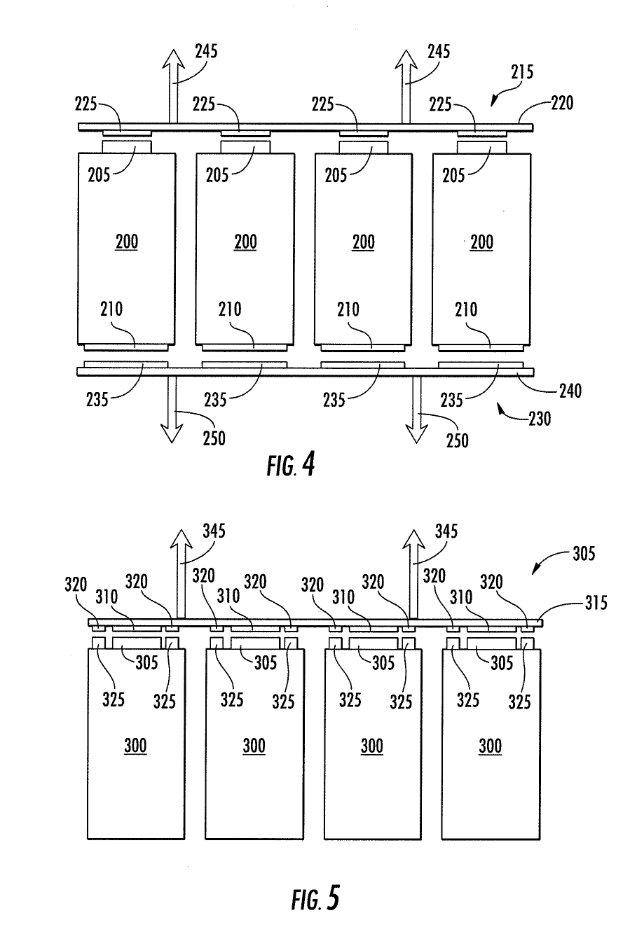

FIG. 4 illustrates an example cutaway side view of a portion of a reconfigurable energy system that depicts four power cells 200, an upper releasable modular interconnect 215 and a lower releasable modular interconnect 230. The upper releasable modular interconnect 215 and the lower releasable modular interconnect 230 complement each other to form an electrical configuration of power cells through a bi-polar arrangement (i.e., connections on opposite faces of the cells). Each power cell 200 includes a respective first terminal 205 on a top surface of the power cell 200 and second terminal 210 on a bottom surface of the power cell 200. The first terminal 205 may have a positive polarity and the second terminal 210 may have a negative polarity. Because the power cells 200 may have terminals on both the top and bottom surfaces of the cells, the upper releasable modular interconnect 215 and the lower releasable modular interconnect 230 may be used to connect the cells in a desired electrical configuration. According to some example embodiments, a power cell may have a top terminal that is electrically isolated from the canister of the power cell, which may be configured to operate as the second terminal.

The upper releasable modular interconnect 215 and the lower releasable modular interconnect 230 may include substrates 220, 240 and releasable contacts 225, 235, respectively. The substrates 220 and 240 may be comprised of any type of insulating material, for example plastic, polyurethane, polyester, polymeric material, other non-conducting organic material, mica, other non-conducting inorganic material, or the like. In some example embodiments, due to the thickness or characteristics of the material that is used for the substrate 220, the substrate may be rigid or flexible. In some example embodiments, where the power cells may need to discharge a reactant gas, a flow path through, for example, apertures in the substrate may be provided.

The releasable contacts 225 and 235 may be portions of conductive interconnect members that form the releasable electrical connections to the terminals of the power cells. The conductive interconnect members may be affixed to a substrate, or disposed between layers of the substrate. In some example embodiments, the conductive interconnect members may be affixed (e.g., glued, thermally bonded, laminated, screen printed, or the like) to a layer of the substrate and apertures may be cut or otherwise removed from the substrate to allow the releasable contacts of the conductive interconnect members to make an electrical connection with a terminal of cell. An opposite side of the conductive interconnect member may be laminated with another layer of the substrate. According to some example embodiments, multiple layers of interconnect members, possibly isolated from each other by non-conductive substrate layers may be used to generate a desired electrical configuration. The conductive interconnect members may be comprised of any type of conductive material including copper, aluminum, silver, conductive inorganic, conductive organics, or the like, and may be embodied as a thin, flexible foil. In some example embodiments, the conductive interconnect members may be punched or cut from a copper sheet (e.g., 1 ounce copper sheet). In some example embodiments, the conductive interconnect members may be configured to support high currents and may have a perimeter to thickness aspect ratio normal in the direction of current flow of, for example, 10:1 or higher.

For illustration purposes, the upper releasable modular interconnect 215 is shown with a gap between the releasable contacts 225 and the terminals 205, but when in operation, the upper releasable modular interconnect 215 is positioned such that releasable contacts 225 form an electrical or physical connection with the terminals 205. According to various example embodiments, the upper releasable modular interconnect 215 thereby overlays an upper plane formed by the top surfaces of the power cell 200. Similarly, for illustration purposes, the lower interconnect substrate 240 is also shown with a gap between the releasable contacts 235 and the terminals 210, but when in operation, the lower releasable modular interconnect 230 is positioned such that releasable contacts 235 form an electrical or physical connection with the terminals 210. According to various example embodiments, the lower releasable modular interconnect 230 thereby underlays a lower plane formed by the bottom surfaces of the power cell 200. According to some example embodiments, a conductive paste or grease may be applied between the releasable contacts and the power cell terminals to facilitate the formation of a high quality (e.g., low impedance) electrical connection. In this regard, according to some example embodiments, the releasable contacts and the terminals may not be in physical releasable contact, but an electrical connection between the releasable contact and the terminal of the power cell may be generated via the conductive paste.

Additionally, the releasable electrical connections that are formed between the terminals 205 and 210 and the releasable contacts 225 and 235 may be facilitated by a force that is applied to bring the releasable contacts toward the terminals. The force may be the result of magnetic coupling between a magnetic member that is affixed, for example, to the releasable modular interconnect or to the power cell. The magnetic member may be paramagnetic, ferromagnetic, ferrimagnetic, or the like. In some example embodiments, the magnetic member may be affixed to the releasable modular interconnect and the power cell case may be imprinted with a magnetic field. In this regard, the magnetic field generated by the power cell may facilitate generation of the connection force.

With the cells 200 and the releasable modular interconnects 215 and 230 installed in a reconfigurable energy system, the releasable modular interconnects 215 and 230 may be removed via a non-destructive interconnect removal forces 245 and 250, respectively. The forces 245 and 230 are sufficient to overcome any connection forces between, for example, the releasable contacts 225, 235 and the power cell terminals 205, 210, such as, for example, those forces generated by magnetic coupling of magnetic members to the power cells. After removal of the upper releasable modular interconnect 215, the releasable modular interconnect 215 may be replaced by another upper releasable modular interconnect. Similarly, after removal of the lower releasable modular interconnect 230, the releasable modular interconnect 230 may be replaced by another lower releasable modular interconnect. The newly installed upper and lower releasable modular interconnects may generate a different electrical configuration of the power cells. In this regard, the electrical configuration of the power cells may be different because a different number of series connected, parallel groups of power cells or a different number of power cells in each parallel group may be achieved through installation of the replacement releasable modular interconnects.

FIG. 5 is a cut-away depiction of an alternative embodiment where the power cells 300 have first terminals 305 (e.g., positive terminals) and second terminals 325 (e.g., negative terminals) accessible on the same face of the power cells 300. According to some example embodiments, when a releasable modular interconnect is configured to form connections with both terminals of a power cell on the same face of the power cell, a single, uni-polar releasable modular interconnect 305 may be used to generate a desired electrical configuration of cells. According to some example embodiments, multiple layers of interconnect members, possibly isolated from each other by non-conductive substrate layers may be used to generate a desired electrical configuration. The releasable modular interconnect 305 includes a substrate 315, first releasable contacts 310 and second releasable contacts 320. The first releasable contacts 310 of the releasable modular interconnect 305 are positioned to form an electrical connection with the first terminals 305 of the power cells 300. The second releasable contacts 320 of the releasable modular interconnect 305 are positioned to form an electrical connection with the second terminals 325. Again, although FIG. 5 depicts a gap between the releasable modular interconnect 305 and the terminals of the cells 300, when in operation, the releasable modular interconnect 305 is positioned such that releasable contacts 310 and 320 form an electrical or physical connection with the terminals 305 and 325, respectively. According to some example embodiments, the releasable contacts and the terminals may not be in physical releasable contact, but an electrical connection between the releasable contact and the terminal of the power cell may be generated via a conductive paste.

If the cells 300 and the releasable modular interconnect 305 are installed in a reconfigurable energy system, the releasable modular interconnect 305 may be removed via a non-destructive interconnect removal force 345. The force 345 is sufficient to overcome any connection forces between, for example, the releasable contacts 310, 320 and the power cell terminals 305, 325, such as, for example, those forces generated by magnetic coupling of magnetic members to the power cells. After removal of the releasable modular interconnect 305, the releasable modular interconnect 305 may be replaced by another releasable modular interconnect. In this regard, the electrical configuration of the power cells may be different because a different number of series connected, parallel groups of power cells or a different number of power cells in each parallel group may be achieved through installation of the replacement releasable modular interconnect.

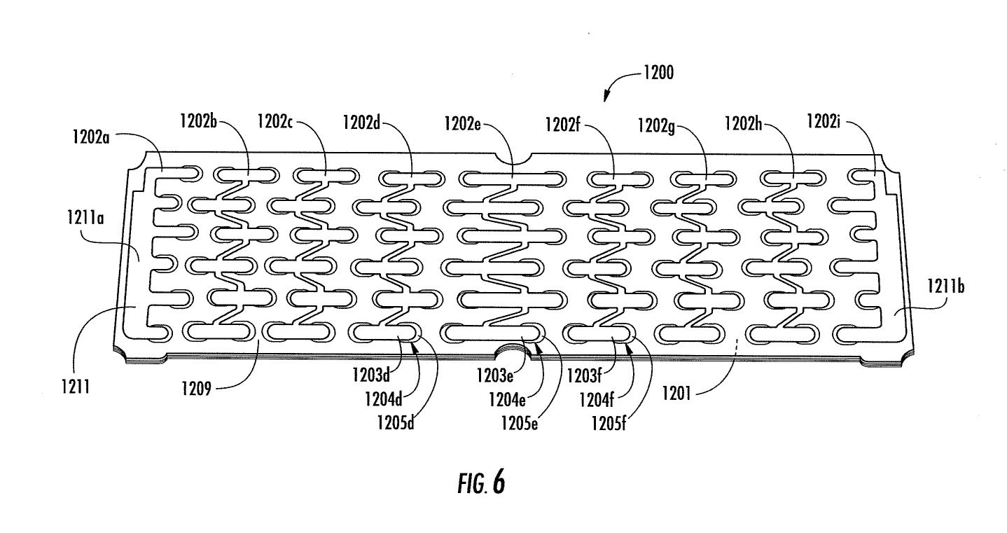

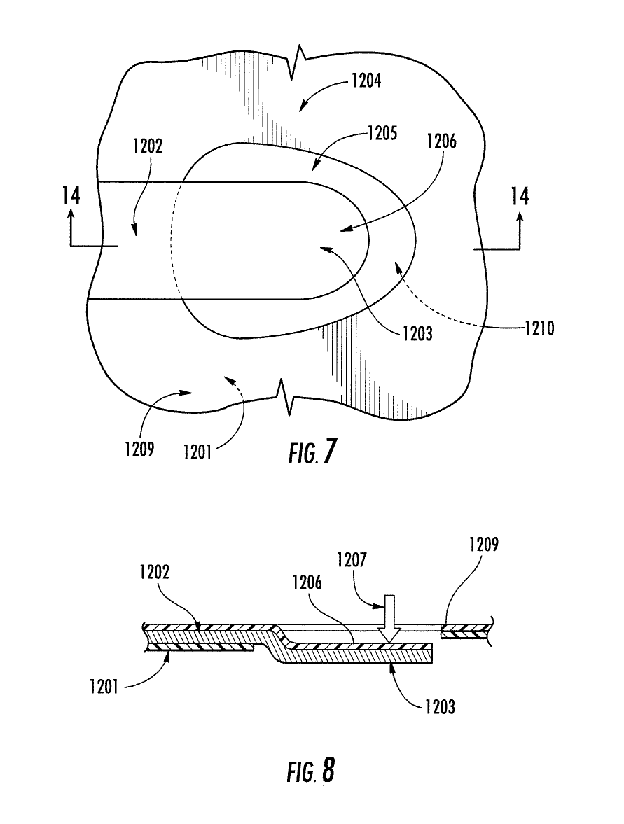

FIG. 6 illustrates an example releasable modular interconnect 1200 that is comprised of the upper substrate layer 1209, the conductive interconnect members 1202 (e.g., conductive interconnect members 1202a through 1202i), and the lower substrate layer 1201. Each of the releasable contacts 1203 (e.g., releasable contacts 1203d through 1203f) is positioned within a respective releasable contact region 1204 (e.g., releasable contact regions 1204d through 1204f). The releasable contact regions 1204 overlay an area where a terminal surface of a power cell would be positioned within a reconfigurable energy system. Via the releasable contacts 1203, the conductive interconnect members 1202 may be configured to form series or parallel electrical connections between power cells to generate a desired electrical configuration. The creation of apertures 1205 result in substrate tabs 1206 (as seen in FIG. 7) within each releasable contact region 1204 that facilitate movement of the releasable contacts 1203 affixed to the tab toward or away from the terminal of a power cell. Additionally, conductive interconnect members 1202a and 1202i include conductive portions configured as interconnect output terminals 1211a and 1211b. The interconnect output terminals 1211a and 1211b are preferably designed to form an electrical connection with output buses of a reconfigurable energy system.

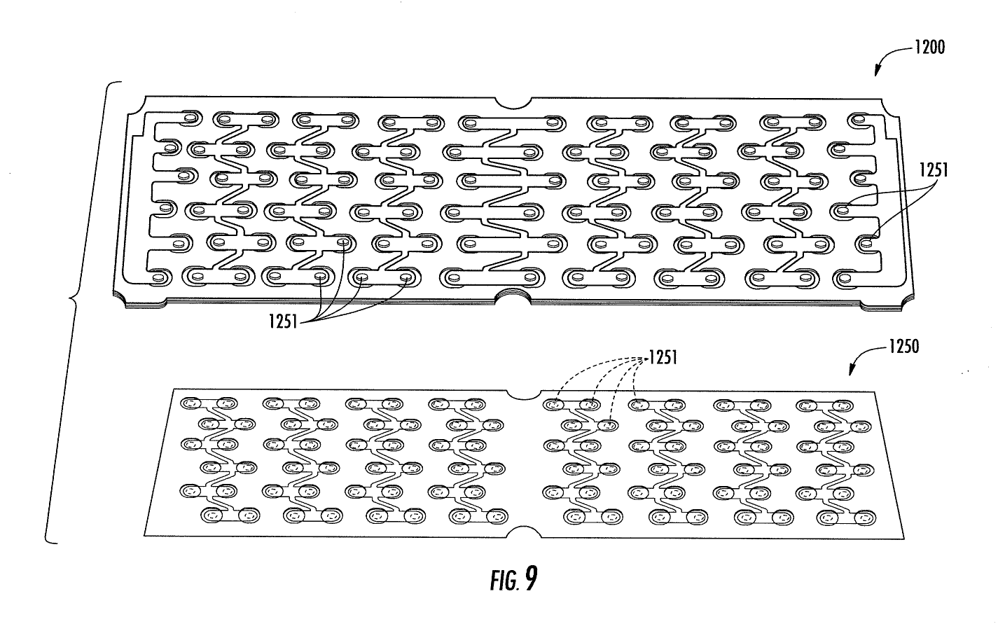

FIGS. 7 and 8 provide more detailed illustrations of an example releasable contact region 1204. Referring to FIG. 7, the releasable contact region 1204 includes a conductive interconnect member 1202 disposed between an upper substrate layer 1209 and a lower substrate layer 1201, a releasable contact 1203, apertures 1205 and 1210, and a substrate tab 1206. Aperture 1210 is an opening in the lower substrate layer 1201 that exposes the underside surface of the releasable contact 1203, and aperture 1205 is an opening in the upper substrate layer 1209 that results in the substrate tab 1206 affixed on a top surface of the releasable contact 1203. Alternatively, in some example embodiments, openings in both layers of the substrate may be created such that the releasable contact 1203 is exposed on both the top-side and under-side surfaces of the releasable contact 1203. Alternatively, in some example embodiments, substrate tab 1206 does not exist such that upper substrate layer 1209 remains intact and constrains releasable contact 1203's upward deflection. In these embodiments, lower substrate layer 1201 may be affixed to conductive interconnect member 1202 associated with the releasable contact. By creating the apertures, substrate tab 1206 and the releasable contact 1203 can be movably supported.

FIG. 8 illustrates the movable nature of the substrate tab 1206 and the releasable contact 1203 out of the planes of the substrate layers. In this regard, the substrate tab 1206 may be movable, and may deflect into and out of a plane formed by the substrate, either above or below the planes formed by the substrate layers. FIG. 8 illustrates the substrate tab 1206 and the releasable contact 1203 after movement in response to a force 1207 being applied in the direction of the arrow. If a power cell were positioned below the releasable contact 1203, the releasable contact 1203 may form an electrical connection with a terminal of the power cell. Due to the flexibility of the substrate tab 1206 and the releasable contact 1203, the releasable contact 1203 is able to deflect as a result of the force 1207 from the plane of the substrate layers and flatten to form a high surface area connection to the terminal of a power cell.

The force 1207 may be generated in a variety of ways. In some example embodiments, a magnetic member may be affixed to the top-side substrate tab 1206 or the releasable contact 1203 to form a magnetic coupling, and thereby generate or contribute to the connection and holding force. Alternatively, in some example embodiments, a pressure cushion may be placed on the releasable modular interconnect 1200 that includes pressure points that push on the substrate tabs to produce the connection and holding force and facilitate forming an electrical connection with terminals of the power cells.

FIG. 9 illustrates releasable modular interconnect 1200 as an upper releasable modular interconnect for use with power cells having terminals on a bottom and top face. Releasable modular interconnect 1250 may be the lower releasable modular interconnect that complements the electrical connections formed by the upper releasable modular interconnect 1200 to form an electrical configuration of power cells. The upper and lower releasable modular interconnects 1200 and 1250 are depicted with magnetic members 1251 affixed to respective substrate tabs so as to magnetically couple with a power cell and form an electrical connection with the terminal of the power cell. Within the plurality of magnetic members, each magnetic member may thereby be associated with a respective contact and be positioned to form a magnetic coupling with a respective power cell to generate a connection force on a contact towards the terminal of a power cell.

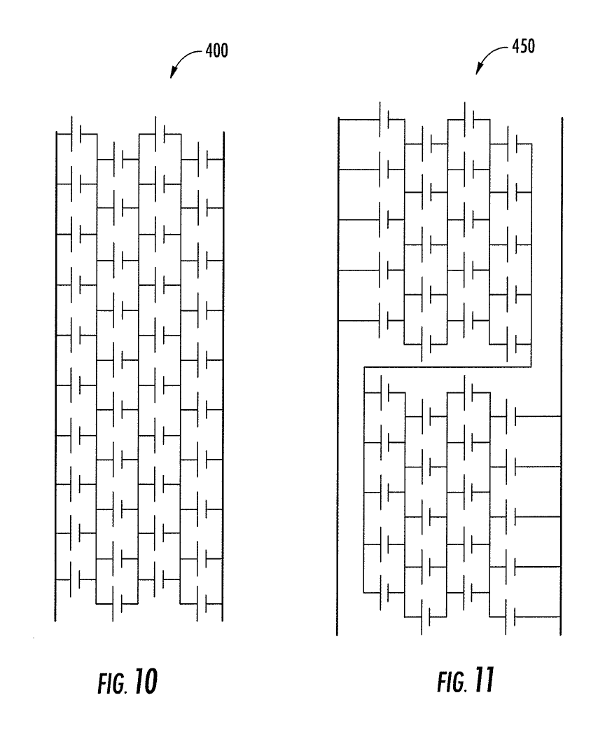

As described above and otherwise herein, the releasability of the releasable modular interconnects facilitate the reconfiguration of energy systems to support different voltage and current carrying capacities. In this regard, a variety of voltages and current capacities can be achieved by a reconfigurable energy system, based on the connections that are made amongst the cells by the releasable modular interconnect. FIGS. 10 and 11 provide two of the many example electrical configurations that can be generated through the use of a releasable modular interconnect that is designed to generate the desired voltage and current capacity outputs using forty power cells. As described above, based on the pattern of the releasable modular interconnect, a number of series connected, parallel groups of cells may be generated through releasable connections to the power cells. The pattern can also connect the parallel groups in series. To describe an electrical configuration of this type, a nomenclature of xsyp can be used, where x is the number of parallel groups that are in series, and y is the number of power cells in a parallel group. Referring to the electrical configuration 400 of FIG. 10, each parallel group includes ten power cells, and four parallel groups are in series. As such, electrical configuration 400 is a 4s10p electrical configuration. With respect to the electrical configuration 450 of FIG. 11, each parallel group includes five power cells and eight of the parallel groups are connected in series. As such, the electrical configuration 450 is an 8s5p configuration.

According to various example embodiments, a releasable modular interconnect or a set of complementary releasable modular interconnects may be constructed that generate the electrical configuration 400 when installed into a reconfigurable energy system. Due to the releasable nature of the releasable modular interconnects, the releasable modular interconnect or set of complementary releasable modular interconnects that form the electrical configuration 400 may be removed from a reconfigurable energy system, and replaced by a second releasable modular interconnect or a second set of complementary releasable modular interconnects to form a different electrical configuration of power cells, such as, for example, the electrical configuration 450.

Further, while a releasable modular interconnect designed to generate, for example, a 4s10p configuration will have a different pattern than a releasable modular interconnect designed to generate an 8s5p configuration, the arrangement of the power cells within a particular housing, according to various example embodiments, may be the same. For example, using the PCAR 105 of FIG. 1, a 4s10p configuration or an 8s5p configuration may be achieved by using differently patterned releasable modular interconnects. As such, according to some example embodiments, merely by replacing a first releasable modular interconnect (or a first set of upper and lower releasable modular interconnects) with a second releasable modular interconnect (or a second set of upper and lower releasable modular interconnects), different voltage and current capacity characteristics of an energy storage system can be achieved using the same PCAR and power cells.

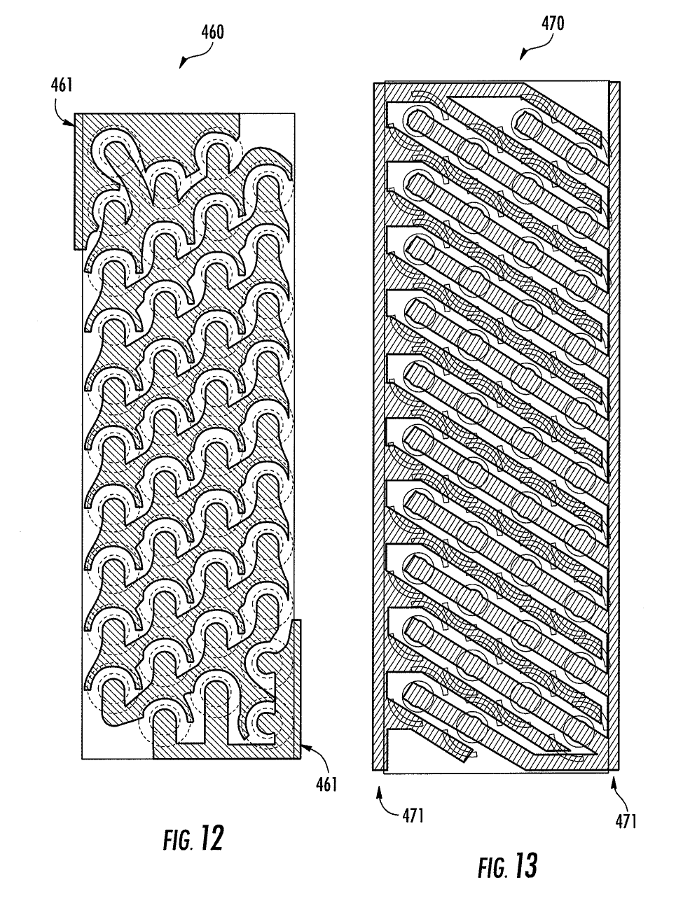

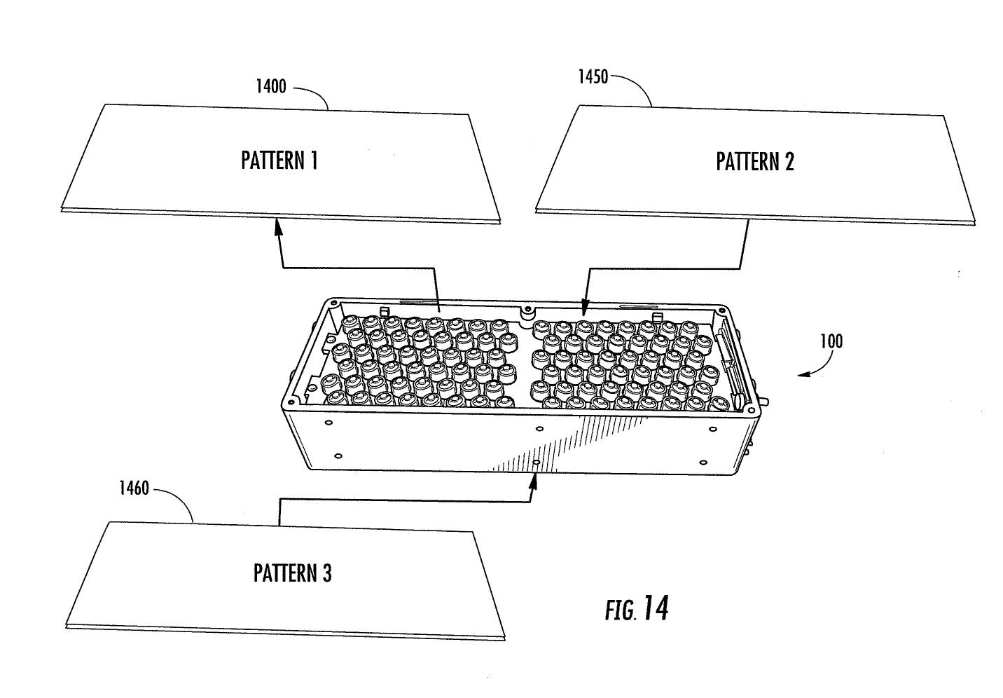

FIGS. 12 and 13 illustrate additional examples of releasable modular interconnects 460 and 470 configured to make positive and negative polarity electrical connections on the same face of the power cells. Releasable modular interconnect 460 includes interconnect output terminals 461. Similarly, releasable modular interconnect 470 includes interconnect output terminals 471. The releasable modular interconnect 460 forms a 10s4p electrical configuration and the releasable modular interconnect 470 forms a completely parallel electrical configuration (i.e., all power cells are connected in parallel). As such, given the same cell placement in a PCAR, the releasable modular interconnect 460 may be replaced with the releasable modular interconnect 470 to generate a different electrical configuration.

Additionally, according to various example embodiments, a releasable modular interconnect or a set of complimentary releasable modular interconnects may be configured to generate an electrical configuration of the power cells that causes the current flow through the parallel groups of cells in a particular manner. For example, the conductive member patterns of a uni-polar releasable modular interconnect or the complementary conductive member patterns of a complementary set of releasable modular interconnects in a bi-polar arrangement may be constructed such that parallel electrical connections are formed in a direction normal to the direction of current flow for the complete electrical configuration.

FIG. 14 illustrates an example removal and replacement of a releasable modular interconnect to reconfigure a energy system, as part of, for example a remanufacture process for the reconfigurable energy system. In this regard, the reconfigurable energy system 100 includes power cells having positive and negative terminals accessible on a top face of the cells. The negative terminals of the cells are also assessable on a bottom face of the cells. As such, in FIG. 14, all the cells are oriented in the same orientation with the positive terminals facing upwards. As result, the reconfigurable energy system need not include a releasable modular interconnect in the lower half of the housing to generate a desired electrical configuration of the power cells. However, a similar process may be performed where sets of complimentary releasable modular interconnects are replaced to reconfigure an energy system.

In FIG. 14, the lid 170 has been removed from the reconfigurable energy system 100. The releasable modular interconnect 1400 was previously installed within the reconfigurable energy system 100, and has since been removed via a non-destructive interconnect removal force. The releasable modular interconnect 1400 may be a uni-polar interconnect have a pattern (i.e., pattern 1) that forms a first electrical configuration of the power cells. Having removed the releasable modular interconnect 1400, releasable modular interconnect 1450 may be installed into the reconfigurable energy system 100 so as to overlay the upward facing positive terminals of the power cells as part of a bi-polar arrangement. The releasable modular interconnect 1460 may also be installed in to the reconfigurable energy system 100 so as to underlay the downward facing negative terminals of the power cells. Replacement of the uni-polar releasable modular interconnect 1400 with the bi-polar arrangement with the complementary releasable modular interconnects 1450 and 1460 having respective complementary patterns, pattern 2 and pattern 3) can form a different electrical configuration of the power cells. The different electrical configuration may be defined by a different number of series connected, parallel groups of power cells and a different number of power cells in each parallel group. While FIG. 14 depicts a uni-polar releasable modular interconnect being replaced by a complementary set of releasable modular interconnects, it is contemplated that a complementary set of releasable modular interconnects may be replaced with a uni-polar releasable modular interconnect, a uni-polar releasable modular interconnect may be replaced with another uni-polar releasable modular interconnect, and a complementary set of releasable modular interconnects may be replaced with another complementary set of releasable modular interconnects.

For example, in a reconfigurable energy system where a set of complementary (e.g., upper and lower) releasable modular interconnects are used, a first set comprising a first releasable modular interconnect and second releasable modular interconnect, may be replaced by a second complementary set of releasable modular interconnects comprising a third releasable modular interconnect and a forth releasable modular interconnect. In this regard, the first releasable modular interconnect may be replaceable with at least the third releasable modular interconnect and the second releasable modular interconnect may be replaceable with at least the fourth releasable modular interconnect. The third and fourth releasable modular interconnects may be configured to form releasable electrical connections with the plurality of power cells that contribute to generating a different electrical configuration of the plurality of power cells. The different electrical configuration may be defined by a second number of series connected, parallel groups of power cells and a second number of power cells in each parallel group.

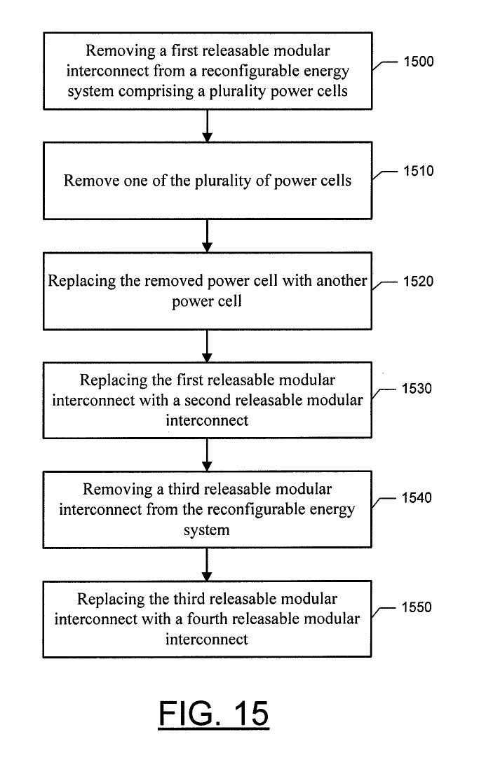

FIG. 15 is a flowchart of an example method for reconfiguring an energy system. The example method includes removing a first releasable modular interconnect from a reconfigurable energy system at 1500. In this regard, removing the first releasable modular interconnect may include removing the first releasable modular interconnect via a first non-destructive interconnect removal force, from the reconfigurable energy system that comprises a plurality power cells. The first releasable modular interconnect may be configured to form releasable electrical connections to at least a first or a second terminal of each of the plurality of power cells. The releasable electrical connections may contribute to generating a first electrical configuration of the plurality of power cells, where the first electrical configuration is defined by a first number of series connected, parallel groups of power cells and a first number of power cells in each parallel group. In some example embodiments, removing, via the first non-destructive interconnect removal force, the first releasable modular interconnect may include overcoming connection forces generated by a plurality of magnetic members of the first releasable modular interconnect. In this regard, each magnetic member may be associated with a respective contact of the first releasable modular interconnect and be positioned to form a magnetic coupling with a respective power cell to generate a respective connection force on the respective contact towards the at least first or second terminal of the respective power cell. In some example embodiments, removing the first releasable modular interconnect includes removing the first modular interconnect from a position overlaying the plurality of power cells and in releasable electrical connections with the first terminals of the power cells.

According to some embodiments, at 1510, the example method includes removing one of the plurality of power cells (e.g., a failed power cell), via a non-destructive cell removal force. The power cells may be accessible for removal or replacement, due to the prior removal of the releasable modular interconnect. Further, according to some embodiments, at 1520, the example method includes replacing the removed power cell with another power cell.

At 1530, the example method also includes replacing the first releasable modular interconnect with a second releasable modular interconnect, according to some embodiments. In this regard, replacing the first releasable modular interconnect may comprise replacing the first releasable modular interconnect with the second releasable modular interconnect, where the second releasable modular interconnect is configured to form releasable electrical connections with the plurality of power cells that contribute to generating a second electrical configuration of the plurality of power cells. The second electrical configuration may be defined by a second number of series connected, parallel groups of power cells and a second number of power cells in each parallel group, where either the second number of series connected, parallel groups of power cells differs from the first number of series connected, parallel groups of power cells, or the second number of power cells in each parallel group differs from the first number of power cells in each parallel group.

At 1540, according to some embodiments, the example method includes removing a third (e.g., a lower) releasable modular interconnect from the reconfigurable energy system. In this regard, the third releasable modular interconnect may be removed, via a second non-destructive interconnect removal force, from a position underlaying the plurality of power cells within the reconfigurable energy system. The third releasable modular interconnect may be configured to form releasable electrical connections to the second terminal of each of the plurality of power cells.

At 1550, the example method includes replacing the third releasable modular interconnect with a fourth releasable modular interconnect, according to some embodiments. In this regard, the second and fourth releasable modular interconnects may be configured to form electrical connections with the plurality of power cells that contribute to generating a second electrical configuration of the plurality of power cells. The second electrical configuration may be defined by a second number of series connected, parallel groups of power cells and a second number of power cells in each parallel group, where either the second number of series connected, parallel groups of power cells differs from the first number of series connected, parallel groups of power cells, or the second number of power cells in each parallel group differs from the first number of power cells in each parallel group.

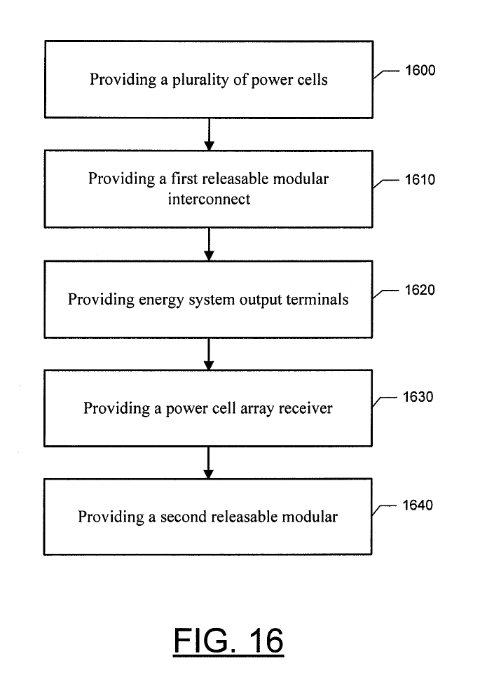

FIG. 16 is flowchart of an example method of manufacturing a reconfigurable energy system. At 1600, the example method includes providing a plurality of power cells, each power cell within the plurality having a first terminal and a second terminal. At 1610, the example method includes providing a first releasable modular interconnect configured to form releasable electrical connections to at least the first terminal of each of the plurality of power cells. In this regard, the releasable electrical connections to the first or second terminal of each of the plurality of power cells may be releasable through application of a first non-destructive interconnect removal force to the first releasable modular interconnect. Further, the releasable electrical connections formed by the first releasable modular interconnect may contribute to generating a first electrical configuration of the plurality of power cells. The first electrical configuration may be defined by a first number of series connected, parallel groups of power cells and a first number of power cells in each parallel group.

According to some embodiments, the example method, at 1620, includes providing energy system output terminals electrically connected through the first releasable modular interconnect to at least some of the plurality of power cells. In this regard, the energy system output terminals may be configured to be connected to an external device for supplying power to the external device.

According to some embodiments, the example method includes, at 1630, providing a power cell array receiver with at least one containment panel. In this regard, the containment panel may include a plurality of apertures, where each aperture is configured to receive one of the plurality of power cells and laterally hold the one power cell in a position that corresponds to a respective contact of the first releasable modular interconnect. According to some embodiments, the plurality of apertures may be arranged in a hexagonal grid.

At 1640, according to some embodiments, the example method further includes providing a second releasable modular interconnect configured to form releasable electrical connections to the second terminal of each of the plurality of power cells. The releasable electrical connections to the second terminal of each of the plurality of power cells may be releasable through application of a second non-destructive interconnect removal force to the first releasable modular interconnect.

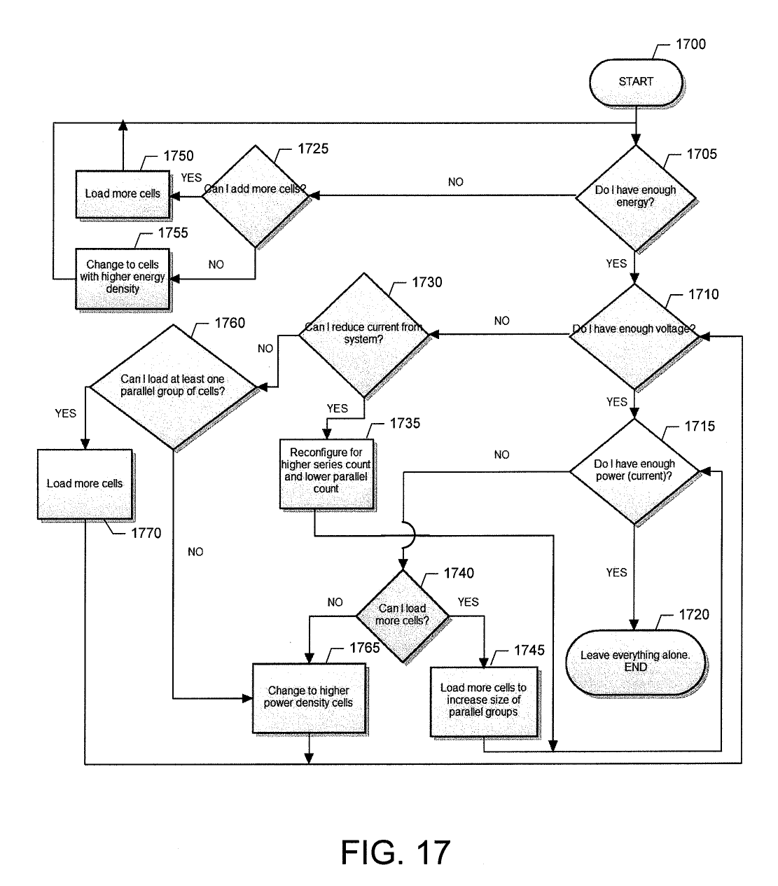

FIG. 17 is a flowchart of an example method of remanufacturing or upgrading a energy system according to various example embodiments. As part of the remanufacture process, a reconfigurable energy system may be modified, for example, through the replacement or reconfiguration of components such that the reconfigurable energy system is suitable for a new application (e.g., to supply power to an electric or hybrid vehicle, to support the power grid, to operate as a back-up power system for a home, or the like). The example method may begin at 1700. At 1705, a determination may be made as to whether the present configuration has sufficient energy (e.g., kilowatt-hour capacity) to support the new application. If the present configuration cannot support the energy requirements of the new application, a determination may be made at 1725 as to whether more power cells can be added to the energy system. If more cells can be added, for example, due to previously empty receiving locations, then more cells can be loaded at 1705 into the energy system at 1750, and a subsequent check of the energy sufficiency can again be made at 1705. If cells cannot be added to the energy system, then cells may be removed and replaced with higher energy density cells at 1755, and a subsequent check of the energy sufficiency can again be made at 1705. In some example embodiments, the removal and replacement of cells with higher energy density cells at 1755 may be achieved by removing at least some cells without replacing the cells due to the higher energy density of the cells of that are replaced.

If the energy system includes sufficient energy at 1705, then a determination may be made at whether the correct voltage is provided by the present configuration of the energy system at 1710. If the present configuration does not support the correct voltage, then a determination may be made as to whether the current output of the system may be reduced at 1730. If the current output can be reduced, then a reconfiguration of the electrical configuration may be performed at 1735 (e.g., by replacing one or more releasable modular interconnects) to achieve a higher series count and a lower parallel count electrical configuration for the cells, and the example method may continue at 1715. Additionally, at 1735, in some example embodiments, the cell count may be reduced. If the current output cannot be reduced at 1730, a determination may be made as to whether the additional parallel groups of cells may be loaded into the energy system. If additional parallel groups of cells may be loaded into the energy system (e.g., due to previously empty receiving locations), then additional cells can be loaded at 1770, and a subsequent check of the voltage may be performed again at 1710. In some example embodiments, in addition to adding more cells at 1770, one or more releasable modular interconnects may be replaced to support a new electrical configuration of the cells. If at 1760 it is determined that additional parallel groups cannot be loaded, then at 1765, the cells may be removed and replaced with higher density cells (similar to 1755), and a subsequent check of the voltage may be performed again at 1710.

If sufficient energy and the correct voltage are attributes of the present configuration of the energy system, then a determination may be made at 1715 as to whether sufficient power or current is provided by the present configuration for the new application. If sufficient power or current is not available via the present configuration, then a determination may be made as to whether more cells may be loaded into the energy system at 1740. If more cells can be loaded, then at 1745, more cells may be loaded to increase the parallel count (i.e., the size of the parallel groups) at 1745, and a subsequent check of the sufficiency of the power or current may be performed at 1715. If more cells cannot be loaded at 1740, then at 1765, the cells may be removed and replaced with higher power density cells (similar to 1755), and a subsequent check of the voltage may be performed again at 1710. If, at 1715, it is determined that sufficient power or current is available in the present configuration, then the present configuration satisfies the requirement of the new application and the example method can end at 1720.

With respect to the replacement of components, which include cells for reconfiguration purposes, the components may be replaced when a releasable modular interconnect is removed from a reconfigurable energy system. In some example embodiments, the components may be removed and replaced because removal of the releasable modular interconnect provides access to the components. Further, as part of a reconfiguration process cells may be added (e.g., when space allows) or removed thereby changing the number of cells prior to re-installation or replacement of the releasable modular interconnect. Further, according to some example embodiments, cells being re-installed or replaced may be oriented differently, in some instances, such that an opposite polarity position of the cell is achieved.

Further, a method of remanufacturing a reconfigurable energy system may include providing a first reconfigurable energy system. In some example embodiments, a second reconfigurable energy system may also be provided of the same or a differing technology as the first reconfigurable energy system. According to various example embodiments, components of the first reconfigurable energy system may be exchanged with components, including power cells, of the second reconfigurable energy system to generate a remanufactured energy system. The components exchanged as part of the remanufacturing process may be of the same or different technologies. Further, in some example embodiments, a PCAR for receiving the cells of a reconfigurable energy system may be removed, replaced or exchanged with a PCAR of a different or the same technology. Different PCAR technologies may support different cell counts or placements within a reconfigurable energy system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements or functions, it should be appreciated that different combinations of elements or functions may be provided by alternative embodiments without departing from the scope of the appended claims. In this regard, for example, different combinations of elements or functions other than those explicitly described above are also contemplated as may be set forth in some of the appended claims. Although specific terms are employed herein, they are used in a generic and descriptive sense only and not for purposes of limitation.

What is claimed is:

1. A reconfigurable energy system comprising:
a plurality of power cells, each power cell within the plurality having a first terminal and a second terminal; and
a first releasable modular interconnect configured to form releasable electrical connections to at least the first or the second terminal of each of the plurality of power cells, the releasable electrical connections to the first or second terminal of each of the plurality of power cells being releasable through application of a first non-destructive interconnect removal force to the first releasable modular interconnect; and
wherein the releasable electrical connections formed by the first releasable modular interconnect contribute to generating a first electrical configuration of the plurality of power cells, the first electrical configuration being defined by a first number of series connected, parallel groups of power cells and a first number of power cells in each parallel group.

2. The reconfigurable energy system of claim 1, wherein the first releasable modular interconnect is replaceable with at least a second releasable modular interconnect, the second releasable modular interconnect being configured to form releasable electrical connections with the plurality of power cells that contribute to generating a second electrical configuration of the plurality of power cells, the second electrical configuration being defined by a second number of series connected, parallel groups of power cells and a second number of power cells in each parallel group, wherein either the second number of series connected, parallel groups of power cells differs from the first number of series connected, parallel groups of power cells or the second number of power cells in each parallel group differs from the first number of power cells in each parallel group.

3. The reconfigurable energy system of claim 1, further comprising output terminals electrically connected through the first releasable modular interconnect to at least some of the plurality of power cells, the output terminals being configured to be connected to an external device for supplying power to the external device.

4. The reconfigurable energy system of claim 1, further comprising:
a power cell array receiver with at least one containment panel, the containment panel including a plurality of apertures, each aperture configured to receive one of the plurality of power cells and laterally hold the one power cell in a position that corresponds to a respective contact of the first releasable modular interconnect.

5. The reconfigurable energy system of claim 1, further comprising:
a power cell array receiver with at least one containment panel, the containment panel including a plurality of apertures arranged in a hexagonal grid, each aperture configured to receive one of the plurality of power cells and laterally hold the one power cell in a position that corresponds to a respective contact of the first releasable modular interconnect.

6. The reconfigurable energy system of claim 1, wherein the first releasable modular interconnect includes:
a plurality of contacts configured to form the releasable electrical connections to the at least first or the second terminal of each of the plurality of power cells; and
a plurality of magnetic members, each magnetic member being associated with a respective contact and being positioned to form a magnetic coupling with a respective power cell to generate a connection force on the respective contact towards the at least first or second terminal of the respective power cell.

7. The reconfigurable energy system of claim 1, wherein for each of the plurality of power cells, the first terminal is disposed on a top surface of a power cell and a second terminal is disposed on a bottom surface of a power cell;
wherein the first releasable modular interconnect is configured to form the releasable electrical connections to the first terminals of each of the plurality of power cells and overlay an upper plane formed by the top surfaces of the power cells; and
wherein the reconfigurable energy system further comprises a second releasable modular interconnect configured to form releasable electrical connections to the second terminal of each of the plurality of power cells and underlay a lower plane formed by the bottom surfaces of the power cells, the releasable electrical connections to the second terminals of each of the plurality of power cells being releasable through application of a second non-destructive interconnect removal force to the second releasable modular interconnect.

8. The reconfigurable energy system of claim 7 wherein the first releasable modular interconnect is replaceable with at least a third releasable modular interconnect and the second releasable modular interconnect is replaceable with at least a fourth releasable modular interconnect, the third and fourth releasable modular interconnects being configured to form releasable electrical connections with the plurality of power cells that contribute to generating a second electrical configuration of the plurality of power cells, the second electrical configuration being defined by a second number of series connected, parallel groups of power cells and a second number of power cells in each parallel group, wherein either the second number of series connected, parallel groups of power cells differs from the first number of series connected, parallel groups of power cells or the second number of power cells in each parallel group differs from the first number of power cells in each parallel group.

9. A method comprising:
removing, via a first non-destructive interconnect removal force, a first releasable modular interconnect from a reconfigurable energy system comprising a plurality power cells, the first releasable modular interconnect being configured to form releasable electrical connections to at least a first or a second terminal of each of the plurality of power cells, the releasable electrical connections contributing to generating a first electrical configuration of the plurality of power cells, the first electrical configuration being defined by a first number of series connected, parallel groups of power cells and a first number of power cells in each parallel group.

10. The method of claim 9, further comprising re-installing the first releasable modular interconnect into the reconfigurable energy system.

11. The method of claim 10 further comprising:
prior to re-installing the first releasable modular interconnect, removing one of the plurality of power cells, via a non-destructive cell removal force; and
replacing the removed power cell with a replacement power cell.

12. The method of claim 11, wherein the removed power cell and the replacement power cell are of a same technology.

13. The method of claim 11, wherein the removed power cell and the replacement power cell are of a different technology.

14. The method of claim 10 further comprising:
prior to re-installing the first releasable modular interconnect, removing a component of the reconfigurable energy system via a non-destructive component removal force, the component being accessible as result of the removal of the first modular interconnect; and
replacing the removed component with a replacement component.

15. The method of claim 14, wherein the removed component and the replacement component are of a same technology.

16. The method of claim 14, wherein the removed power cell and the replacement power cell are of a different technology.

17. The method of claim 9, further comprising replacing the first releasable modular interconnect with a second releasable modular interconnect.

18. The method of claim 17 further comprising:
prior to replacing the first releasable modular interconnect, removing one of the plurality of power cells, via a non-destructive cell removal force; and
replacing the removed power cell with another power cell.

19. The method of claim 17 further comprising:
prior to replacing the first releasable modular interconnect, removing a component of the reconfigurable energy system via a non-destructive component removal force, the component being accessible as result of the removal of the first modular interconnect; and
replacing the removed component with another removed component.

20. The method of claim 9, wherein replacing the first releasable modular interconnect includes replacing the first releasable modular interconnect with a second releasable modular interconnect, the second releasable modular interconnect being configured to form releasable electrical connections with the plurality of power cells that contribute to generating a second electrical configuration of the plurality of power cells, the second electrical configuration being defined by a second number of series connected, parallel groups of power cells and a second number of power cells in each parallel group, wherein either the second number of series connected, parallel groups of power cells differs from the first number of series connected, parallel groups of power cells or the second number of power cells in each parallel group differs from the first number of power cells in each parallel group.

21. The method of claim 9 wherein removing, via the first non-destructive interconnect removal force, the first releasable modular interconnect includes overcoming connection forces generated by a plurality of magnetic members of the first releasable modular interconnect, each magnetic member being associated with a respective contact of the first releasable modular interconnect and being positioned to form a magnetic coupling with a respective power cell to generate a respective connection force on the respective contact towards the at least first or second terminal of the respective power cell.

22. The method of claim 9 wherein removing, via the first non-destructive interconnect removal force, the first releasable modular interconnect from a reconfigurable energy system comprising a plurality power cells includes removing the first releasable modular interconnect from a position overlaying the plurality of power cells and in releasable electrical connections with the first terminals of the power cells; and
wherein the method further comprises:
replacing the first releasable modular interconnect with a second releasable modular interconnect;
removing, via a second non-destructive interconnect removal force, a third releasable modular interconnect from a position underlaying the plurality of power cells within the reconfigurable energy system, the third releasable modular interconnect being configured to form releasable electrical connections to the second terminal of each of the plurality of power cells; and
replacing the third releasable modular interconnect with a fourth releasable modular interconnect, the second and fourth releasable modular interconnects being configured to form electrical connections with the plurality of power cells that contribute to generating a second electrical configuration of the plurality of power cells, the second electrical configuration being defined by a second number of series connected, parallel groups of power cells and a second number of power cells in each parallel group, wherein either the second number of series connected, parallel groups of power cells differs from the first number of series connected, parallel groups of power cells or the second number of power cells in each parallel group differs from the first number of power cells in each parallel group.

23. A method of manufacturing a reconfigurable energy system, the method comprising:
providing a plurality of power cells, each power cell within the plurality having a first terminal and a second terminal; and
providing a first releasable modular interconnect configured to form releasable electrical connections to at least the first or the second terminal of each of the plurality of power cells, the releasable electrical connections to the first or second terminal of each of the plurality of power cells being releasable through application of a first non-destructive interconnect removal force to the first releasable modular interconnect; and
wherein the releasable electrical connections formed by the first releasable modular interconnect contribute to generating a first electrical configuration of the plurality of power cells, the first electrical configuration being defined by a first number of series connected, parallel groups of power cells and a first number of power cells in each parallel group.

24. The method of claim 23, further comprising providing output terminals electrically connected through the first releasable modular interconnect to at least some of the plurality of power cells, the output terminals being configured to be connected to an external device for supplying power to the external device.

25. The method of claim 23, further comprising providing a power cell array receiver with at least one containment panel, the containment panel including a plurality of apertures, each aperture configured to receive one of the plurality of power cells and laterally hold the one power cell in a position that corresponds to a respective contact of the first releasable modular interconnect.

26. The method of claim 23, further comprising providing a power cell array receiver with at least one containment panel, the containment panel including a plurality of apertures arranged in a hexagonal grid, each aperture configured to receive one of the plurality of power cells and laterally hold the one power cell in a position that corresponds to a respective contact of the first releasable modular interconnect.

27. The method of claim 23, wherein providing the first releasable modular interconnect includes providing the first releasable modular interconnect, wherein the first releasable modular interconnect is configured to form releasable electrical connections to the first terminal of each of the plurality of power cells; and
wherein the method further comprises providing a second releasable modular interconnect configured to form releasable electrical connections to the second terminal of each of the plurality of power cells, the releasable electrical connections to the second terminal of each of the plurality of power cells being releasable through application of a second non-destructive interconnect removal force to the first releasable modular interconnect.
